(19) United States
(12) Patent Application Publication
(10) Pub. No.: US 2024/0345412 A1
(43) Pub. Date: Oct. 17, 2024

(54) 3D SWITCHABLE DEVICE AND DISPLAY DEVICE COMPRISING THE SAME

(71) Applicant: DONGJIN SEMICHEM CO., LTD., Incheon (KR)

(72) Inventors: Jin Wook CHOI, Suwon-si (KR); Ik Soo LEE, Seoul (KR)

(21) Appl. No.: 18/756,203

(22) Filed: Jun. 27, 2024

Related U.S. Application Data
(63) Continuation of application No. PCT/KR2022/021676, filed on Dec. 29, 2022.

(30) Foreign Application Priority Data
Dec. 31, 2021 (KR) 10-2021-0194071

(51) Int. Cl. G02B 30/25; G02F 1/1333; G02F 1/1335; G02F 1/1337; G02F 1/1343

(52) U.S. Cl. CPC G02B 30/25; G02F 1/133357; G02F 1/133526; G02F 1/1337; G02F 1/134363

(57) ABSTRACT

A 3D switchable device includes a base substrate; a liquid crystal member including a first liquid crystal electrode disposed on the base substrate, a liquid crystal layer disposed on the first liquid crystal electrode, which selectively blocks or allows 2D polarization and 3D polarization; a lenticular lens member disposed on the liquid crystal member; and a cover substrate disposed on the lenticular lens member.

### CROSS-REFERENCE TO RELATED APPLICATIONS

This application is a Continuation of International Application No. PCT/KR2022/021676 filed Dec. 29, 2022, which claims priority from Korean Application No. 10-2021-0194071 filed Dec. 31, 2021. The aforementioned applications are incorporated herein by reference in their entireties.

### BACKGROUND

### 1. Technical Field

The present disclosure relates to a 3D switchable device and display device comprising the same.

### 2. Description of the Related Art

The services that will be realized through the acceleration of information built on the basis of today's ultra-high-speed information and communication networks are evolving into multimedia services for viewing and listening, centered on digital terminals that process text, voice, and video at high speeds. Ultimately, these services are developing into hyper-spatial, realistic 3D information and communication services that transcend time and space and allow users to see, feel, and enjoy content realistically and three-dimensionally.

In general, stereoscopic images that express three dimensions are perceived based on the principle of stereo vision through the two eyes. The parallax between the two eyes, that is, the binocular parallax that occurs since the two eyes are about 65 mm apart, is the most important factor in stereoscopic perception. In other words, the left and right eyes see different two-dimensional images, and when these two images are transmitted to the brain through the retinas, the brain accurately fuses them together to reproduce the depth and reality of the original three-dimensional image. This ability is commonly referred to as stereography.

Stereoscopic image display devices use binocular parallax, and depending on whether the observer wears separate glasses, methods such as the stereoscopic polarization method, time division method, non-stereoscopic(autostereoscopic) parallax-barrier method, lenticular method, and blinking light method are used.

Among them, the conventional display device for displaying 2D/3D images that selectively displays 2D images and 3D images using a lenticular method includes a liquid crystal panel that implements a 2D image (hereinafter referred to as “2D polarization” for convenience of explanation) and a 3D image (hereinafter referred to as “3D polarization” for convenience of explanation), a liquid crystal variable module that selectively passes either 2D or 3D polarization, and a lenticular lens module that provides binocular parallax for 3D polarization.

In a conventional display device for displaying 2D/3D images with this configuration, among a 2D polarization and 3D polarization emitted from the display panel, the 3D polarization receives binocular parallax from the lenticular lens module, while the 2D polarization passes through the lenticular lens module unchanged.

In addition, the liquid crystal variable module selectively changes the orientation direction of the liquid crystal by applying a voltage to pass 3D polarization and block the passage of 2D polarization, or to pass 2D polarization and block 3D polarization, thereby enabling the transmission of two-dimensional or three-dimensional images to the viewer.

However, in such conventional display devices for displaying 2D/3D images, by attaching a liquid crystal variable module and a lenticular lens module onto the display panel, the thickness increases, the number of parts increases, productivity decreases, and quality issues of each part occur.

Additionally, as the light emitted from the display panel passes through several layers, physical phenomena such as transmission, reflection, and absorption occur at the interface of each medium, resulting in a decrease in image quality, and due to the adhesive method between modules, various quality decreases such as the moire phenomenon and Newton's ring phenomenon.

Moreover, if a touch screen panel is additionally attached to the top to implement the touch function, the problem further increases.

### SUMMARY

The purpose of the present disclosure is to provide a 3D switchable device with superior image quality and a display device including the same by integrating the liquid crystal member and the lenticular lens member, thereby reducing thickness, the number of components, and manufacturing time.

In addition, the purpose of the present disclosure is to provide a 3D variable device that is integrated with a touch screen panel and a display device including the same.

The above-mentioned objectives and other objectives will be understood from the description provided below.

To address the above challenges, in one aspect, the present disclosure provides a 3D switchable device comprising a base substrate; a liquid crystal member including a first liquid crystal electrode on the base substrate, a liquid crystal layer on the first liquid crystal electrode, selectively blocking 2D polarization and 3D polarization; a lenticular lens member on the liquid crystal member; and a cover substrate on the lenticular lens member.

In addition, in one embodiment, there is provided a 3D switchable device comprising a base substrate; a liquid crystal member including a liquid crystal layer on the first liquid crystal electrode on the base substrate, selectively blocking 2D polarization and 3D polarization; a lenticular lens member on the liquid crystal member; a cover substrate on the lenticular lens member; and a first touch electrode for a touch screen interposed between the lenticular lens member and the cover substrate.

In addition, in one embodiment, there is provided a display device comprising a 3D switchable device; and a display panel located below the 3D switchable device, outputting an image to the 3D switchable device.

The above embodiments and additional embodiments are described in detail below.

The 3D switchable device and the display device according to one embodiment of the present disclosure can reduce thickness, number of parts, and manufacturing time, and improve image quality by integrating the liquid crystal member and the lenticular lens member.

In addition, the 3D switchable device and the display device according to one embodiment of the present disclosure can further increase the above effect by integrating the touch screen member into the 3D switchable device.

The above effects and other effects will be described in detail below.

### BRIEF DESCRIPTION OF THE DRAWINGS

FIGS. 1-7 are cross-sectional views schematically showing the layer structure of the 3D switchable device and the display device according to an embodiment of the present disclosure,

FIG. 8 is a cross-sectional view schematically showing the layer structure of the 3D switchable device and the display device according to Example 5,

FIG. 9 is a cross-sectional view schematically showing the layer structure of a 3D switchable device and a display device according to a modified example of the present disclosure,

FIGS. 10 and 11 are cross-sectional views schematically showing the layer structures of the 3D switchable device and the display device according to Example 12 and Example 13, respectively, and

FIGS. 12 and 13 are photographs showing the Moire phenomenon and Newton's ring phenomenon, respectively.

### LIST OF REFERENCE NUMERALS

10: base substrate
11: first liquid crystal electrode
12: second liquid crystal electrode
20: liquid crystal member
21: liquid crystal layer
22: first liquid crystal alignment layer
23: second liquid crystal alignment layer
30: lenticular lens member
31: anisotropic lens
32: isotropic planarization layer
33: first lens alignment layer
34: second lens alignment layer
40: cover substrate
51: first touch electrode
52: second touch electrode
60: insulation layer
80: intermediate substrate
81: adhesive layer
90: touch screen substrate
91: upper electrode
92: insulating layer
93: lower electrode
94: adhesive layer
110: adhesive layer
100: display panel

### DETAILED DESCRIPTION

Prior to a description of the present disclosure, it should be noted that the terms used in the present specification are used only to describe specific examples and are not intended to limit the scope of the present disclosure which will be defined only by the appended claims.

Unless otherwise defined herein, all terms including technical and scientific terms used herein have the same meaning as commonly understood by those who are ordinarily skilled in the art to which the present disclosure pertains.

Unless otherwise stated herein, it will be further understood that the terms “comprise”, “comprises”, and “comprising”, when used in this specification, specify the presence of stated features, regions, integers, steps, operations, elements and/or components but do not preclude the presence or addition of one or more other features, regions, integers, steps, operations, elements, components and/or groups thereof.

In addition, throughout this specification, the same symbols may have the same meaning unless otherwise specified, and various embodiments of the present invention may be combined with any other embodiments unless clearly stated otherwise.

Meanwhile, terms such as Step 1-1 and Step 1-2 are used throughout this specification, but this is only to aid understanding of the embodiments of the present invention, and does not refer to the execution order of the manufacturing method Steps.

Hereinafter, embodiments of the present disclosure and the effects thereof will be described in detail below.

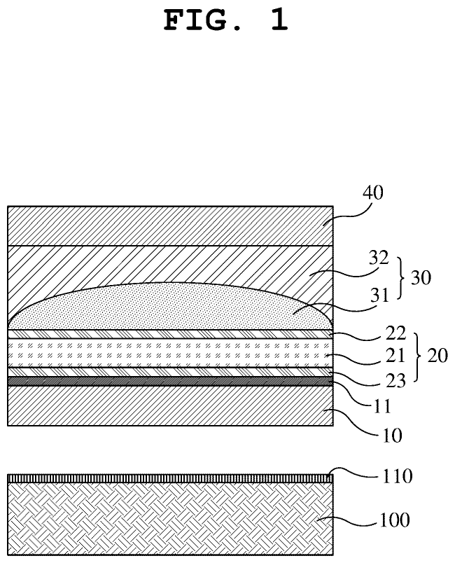

FIG. 1 is a cross-sectional view schematically showing the layer structure of a 3D switchable device and a display device according to an embodiment of the present disclosure. The 3D switchable device comprises a base substrate 10; a liquid crystal member 20 including a first liquid crystal electrode 11 on the base substrate 10 and a liquid crystal layer 21 on the first liquid crystal electrode 11, selectively blocking 2D polarization and 3D polarization; a lenticular lens member 30 on the liquid crystal member 20; and a cover substrate 40 on the lenticular lens member.

The liquid crystal member 20 may include a liquid crystal layer 21, a first liquid crystal alignment layer 23 adjacent to the base substrate 10 and located on one side of the liquid crystal layer 21, and a second liquid crystal alignment layer 22 located on the other side of the liquid crystal layer 21.

A first liquid crystal electrode 11 is formed on the top of the base substrate 10, and a liquid crystal member 20 that selectively blocks 2D polarization and 3D polarization is formed on the first liquid crystal electrode 11. As a specific example, the first liquid crystal electrode 11 is formed in a pattern and causes a potential difference between neighboring electrodes to adjust the liquid crystal of the liquid crystal member 20, thereby selectively allowing 2D polarization and 3D polarization to be blocked or transmitted. An example of the liquid crystal member 20 may be an IPS type (In-Plane Switching type). In the case of the IPS type, the thickness can be further reduced by forming an electrode only on one side of the liquid crystal member 20, and an insulating layer added to insulate from the second touch electrode, which will be described later, is unnecessary.

The lenticular lens member 30 includes an anisotropic lens 31 and an isotropic planarization layer 32 on the anisotropic lens 31. The anisotropic lens 31 is configured to generate binocular parallax as 3D polarization passes through the lens. The shape and pattern of the anisotropic lens 31 are not limited, and any known shapes can be adopted. An isotropic planarization layer 32 is located on top of the anisotropic lens 31. The lenticular lens member 30 can be manufactured by forming the anisotropic lens 31 after forming the isotropic planarization layer 32 concavely into a shape corresponding to the shape of the anisotropic lens 31.

Meanwhile, the isotropic planarization layer 32 of the lenticular lens member 30 may be manufactured by applying room temperature curing or UV curing method. At this time, the room temperature curing method may be performed at temperatures ranging from 15° C. to 35° C., but it is not limited thereto.

The separation distance between the liquid crystal member 20 and the lenticular lens member 30 may be 350 μm or less, preferably 300 μm or less, and more preferably 100 μm or less. More preferably, the liquid crystal member and the lenticular lens member may be in direct contact. The 3D switchable device according to an embodiment of the present disclosure integrates the liquid crystal member 20 and the lenticular lens member 30, thereby reducing thickness, number of parts, and manufacturing time, and improving image quality.

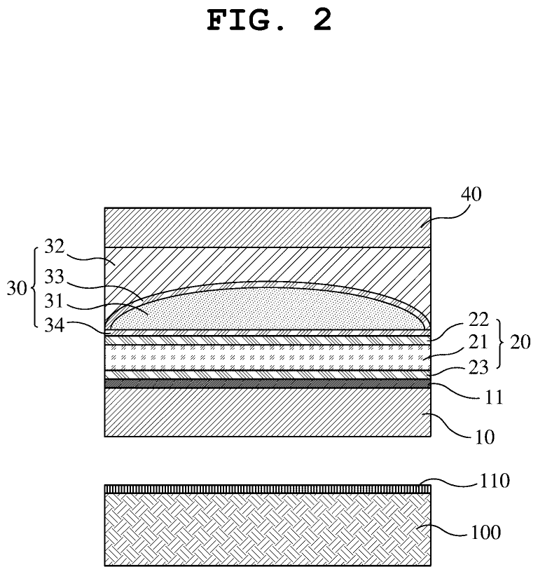

FIG. 2 is a cross-sectional view schematically showing the layer structure of a 3D switchable device and a display device according to another embodiment of the present disclosure. The 3D switchable device may further include a first lens alignment layer 33 on one side of the anisotropic lens 31 of the lenticular lens member 30 and a second lens alignment layer 34 adjacent to the liquid crystal member and disposed on the other side of the anisotropic lens. The anisotropic lens 31 can be oriented as desired through the lens alignment layers 33 and 34. Meanwhile, the lens alignment layers 33 and 34 may be omitted by using a method that does not require an alignment layer, such as a photo-alignment method.

In the 3D switchable device according to an embodiment of the present disclosure, the upper surface of the liquid crystal member 20 and the lower surface of the lenticular lens member 30 can be integrated by contacting each other without an additional substrate. the conventional process of separately manufacturing the liquid crystal module and the lenticular lens module and then adhering the substrate of the liquid crystal module to the substrate of the lenticular lens module using adhesive can be excluded. As a result, the thickness, number of parts, and manufacturing time of the display device can be reduced, and superior image quality can be achieved.

As an example of manufacturing a 3D switchable device according to an embodiment of the present disclosure, it can be manufactured integrally by separately manufacturing the upper and lower structures based on liquid crystal, assembling them, and then injecting the liquid crystal.

For example, the 3D switchable device can be manufactured integrally through a process comprising Step 1-1 of manufacturing the lower structure by forming the first liquid crystal electrode 11 and the bottom liquid crystal alignment layer 23 on the base substrate 10, Separately, Step 1-2 of forming the upper structure by forming the lenticular lens member 30 on the lower surface of the cover substrate 40 and then forming the upper liquid crystal alignment layer 22 on the lower surface of the lenticular lens member 30, and Step 2 of injecting liquid crystal into the area between the upper structure and the lower structure. Thereafter, a display device can be manufactured by attaching a 3D switchable device to the display panel using an adhesive layer or the like.

As a result, the thickness, number of parts, and manufacturing time of the display device can be reduced, and superior image quality can be achieved.

Meanwhile, various manufacturing methods for each layer are possible, including wet methods such as coating and dry methods such as deposition.

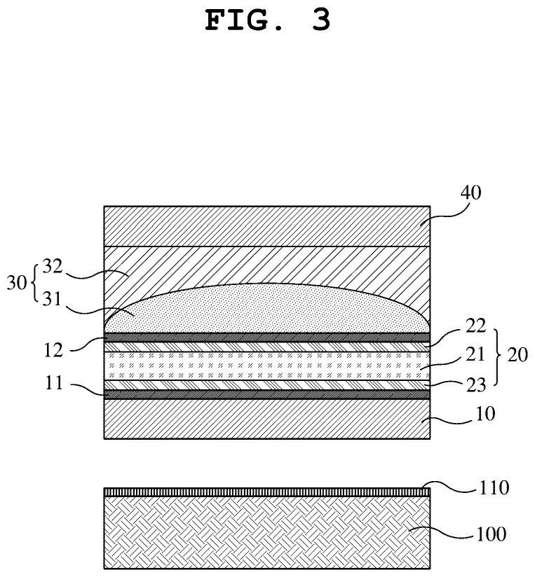

FIG. 3 is a cross-sectional view schematically showing the layer structure of a 3D switchable device and a display device according to another embodiment of the present disclosure. The liquid crystal member 20 may further include a second liquid crystal electrode 12 on the liquid crystal layer 21 facing the first liquid crystal electrode 11. When the upper liquid crystal alignment layer 22 is present, the second liquid crystal electrode 12 may be located on the upper liquid crystal alignment layer 22. In this case, the liquid crystal member 20 may be a TN type (Twisted Nematic type) or a VA type (Vertical Alignment type).

In this case, the Step 1-2 of manufacturing the upper structure as mentioned above can be modified to include forming a lenticular lens member 30 on the underside of the cover substrate 40, then forming the second liquid crystal electrode 12 on the underside of the lenticular lens member 30, and subsequently forming the upper liquid crystal alignment layer 22 to manufacture the upper structure.

In FIGS. 3 to 7, the lens alignment layer on the upper and lower surfaces of the anisotropic lens was not illustrated, but the lens alignment layer may or may not exist, and its presence is not limited.

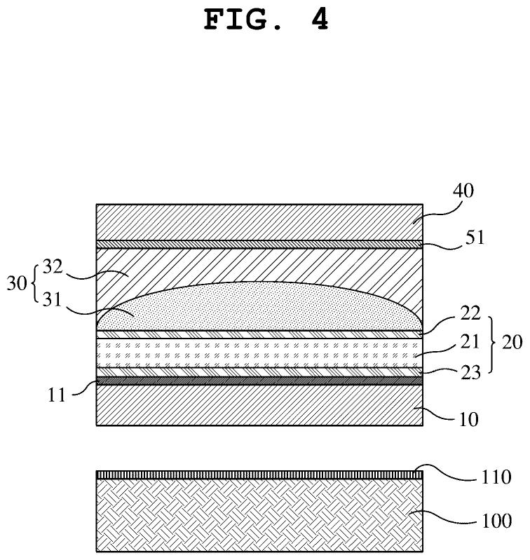

FIG. 4 is a cross-sectional view schematically showing the layer structure of a 3D switchable device and a display device according to another embodiment of the present disclosure, wherein the 3D switchable device also has an integrated touch screen panel. As shown, the 3D switchable device comprises a base substrate 10; a liquid crystal member 20 including a first liquid crystal electrode 11 on the base substrate 10 and a liquid crystal layer 21 on the first liquid crystal electrode 11, selectively blocking 2D polarization and 3D polarization; a lenticular lens member 30 on the liquid crystal member 20; a cover substrate 40 on the lenticular lens member; and a first touch electrode 51 for a touch screen interposed between the lenticular lens member 30 and the cover substrate 40.

The first touch electrode 51 for a touch screen is further included between the cover substrate 40 and the lenticular lens member 30. This is a method in which the touch electrode is implemented as a single layer. For example, it may be a self-capacitance method in which individual electrodes are formed for each specific area such as a pixel to recognize a touch.

By integrating the touch screen unit into the 3D switchable device, the thickness, number of parts, and process time can be further reduced, and image quality can be improved compared to the existing touch screen panel attachment method.

Additionally, as the first touch electrode is disposed on the upper side of the 3D switchable device, better touch sensitivity can be achieved.

In the manufacturing method of the structure in FIG. 4, the above-described Step 1-2 of manufacturing the upper structure can be modified to include forming the first touch electrode 51 on the underside of the cover substrate 40, forming the lenticular lens member 30, and then forming the upper liquid crystal alignment layer 22 on the underside of the lenticular lens member 30.

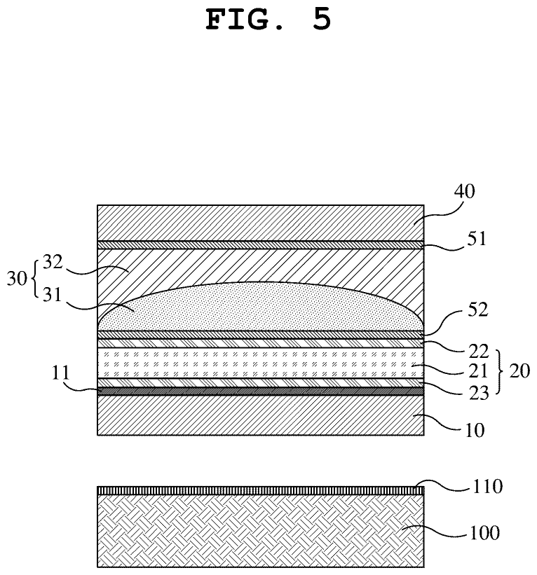

FIG. 5 is a cross-sectional view schematically showing the layer structure of a 3D switchable device and a display device according to another embodiment of the present disclosure. The 3D switchable device may further include a second touch electrode 52 for a touch screen interposed between the lenticular lens member 30 and the liquid crystal member 20. This is a method in which the touch electrode is implemented in two layers. For example, it may be a mutual-capacitance method that measures the capacitance formed at the intersection of the horizontal and vertical axes with a grid electrode structure.

In the manufacturing method of the structure in FIG. 5, the above-described Step 1-2 of manufacturing the upper structure can be modified to include forming the first touch electrode 51 on the underside of the cover substrate 40, forming the lenticular lens member 30, forming the second touch electrode 52 on the underside of the lenticular lens member 30, and then forming the upper liquid crystal alignment layer 22 on the underside of the second touch electrode 52.

Meanwhile, the methods for forming the first touch electrode 51 and the second touch electrode 52 can be used without limitation, and common formation methods in the art may be used. Preferably, they are formed by a deposition method, or by coating and/or curing a solution or a conductive polymer, but the present disclosure is not limited thereto.

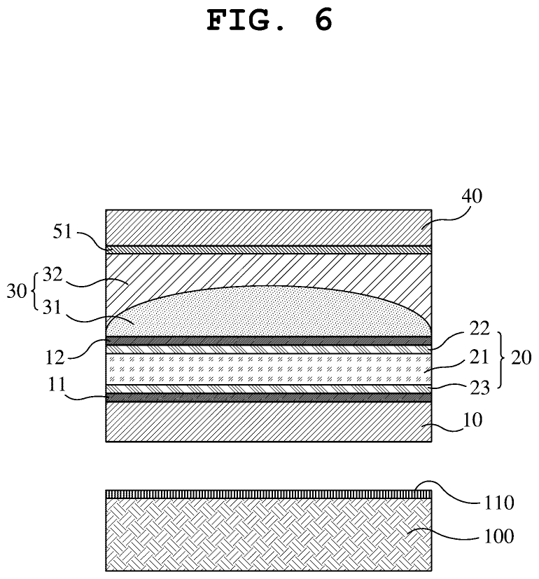

FIG. 6 is a cross-sectional view schematically showing the layer structure of a 3D switchable device and a display device according to another embodiment of the present disclosure. In the structure of FIG. 4, the liquid crystal member 20 has a structure that further includes the above-described second liquid crystal electrode 12.

In this embodiment, the liquid crystal member 20 may be a TN type (Twisted Nematic type) or a VA type (Vertical Alignment type). In addition, it may be a structure in which a first touch electrode 51 for a touch screen exists between the cover base 40 and the lenticular lens member 30. For example, it may be a self-capacitance method in which individual electrodes are formed for each specific area such as a pixel to recognize a touch. In addition, it may be a mutual-capacitance method that measures the capacitance formed at the intersection of the horizontal and vertical axes with a grid electrode structure. In the case of the mutual capacitance method, the second liquid crystal electrode may also serve as another touch electrode.

In the manufacturing method of the structure of FIG. 6, the above-described Step 1-2 of manufacturing the upper structure can be modified to include forming the first touch electrode 51 on the underside of the cover substrate 40, forming the lenticular lens member 30, forming the second liquid crystal electrode 12 on the underside of the lenticular lens member 30, and forming the upper liquid crystal alignment layer 22 on the underside of the second liquid crystal electrode 12.

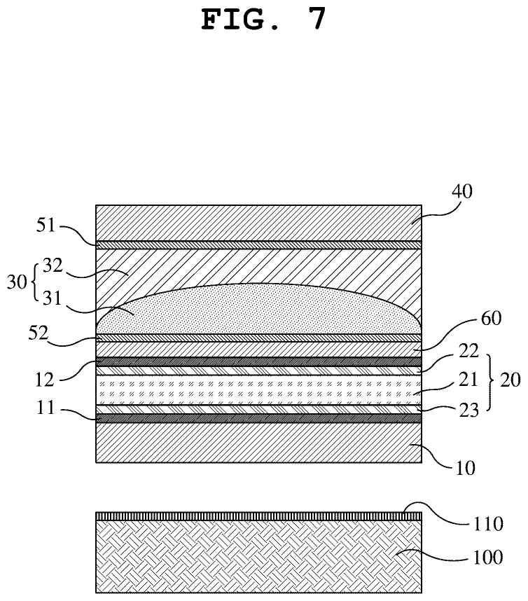

FIG. 7 is a cross-sectional view schematically showing the layer structure of a 3D switchable device and a display device according to another embodiment of the present disclosure. Similar to the embodiment shown in FIG. 6, the 3D switchable device includes a second liquid crystal electrode 12, a second touch electrode 52 for the touch screen between the lenticular lens member 30 and the liquid crystal member 20. Further, an insulating layer 60 is provided between the second touch electrode 52 and the second liquid crystal electrode 12.

In this embodiment, the liquid crystal member 20 may be a TN type (Twisted Nematic type) or a VA type (Vertical Alignment type). In addition, it may be a mutual-capacitance method that measures the capacitance formed at the intersection of the first touch electrode 51 and the second touch electrode 52.

In the manufacturing method of the structure of FIG. 7, the above-described Step 1-2 of manufacturing the upper structure can be modified to include forming the first touch electrode 51 on the underside of the cover substrate 40, forming the lenticular lens member 30, forming the second touch electrode 52 on the underside of the lenticular lens member 30, forming the insulating layer 60, forming the second liquid crystal electrode 12 on the underside of the insulating layer 60, and forming the upper liquid crystal alignment layer 22 on the underside of the second liquid crystal electrode 12.

Meanwhile, the above-described 3D switchable device may not include an adhesive layer inside, thereby decreasing the thickness, number of parts, and processing time of the display device. It can also yield a better image quality.

In addition, the above-described 3D switchable device may not include an air layer inside, thereby resulting in significantly superior image quality.

At this time, as described above, when the 3D switchable device does not include an adhesive layer inside, there is a greater possibility that it does not contain an air layer inside, and thus a significantly superior image quality can be achieved.

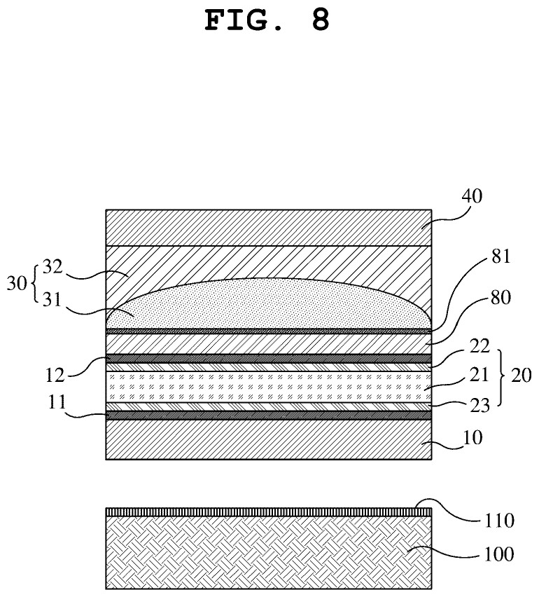

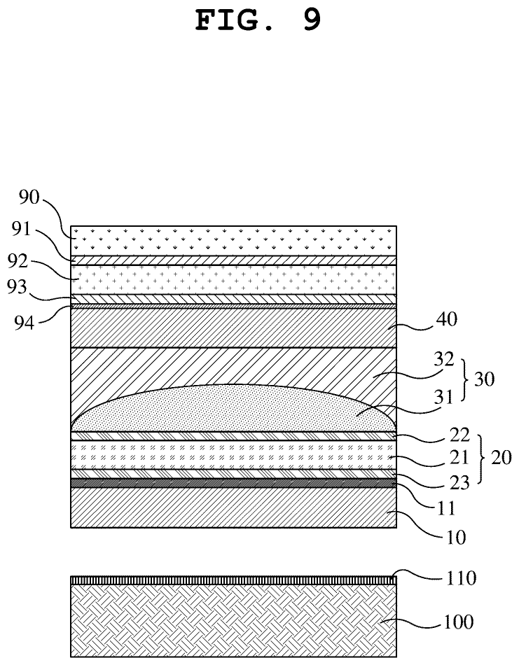

Meanwhile, FIG. 9 is a modified example of the embodiment shown in FIG. 8 according to the present disclosure. As shown in FIG. 9, the touch screen panel may be attached to the cover substrate 40 using an adhesive. Specifically, the upper electrode 91 is formed under the touch screen substrate 90 by a metal deposition method, an insulating layer 92 is formed under the upper electrode, a lower electrode 93 is formed under the insulating layer, and then an adhesive layer 94 is formed under the lower electrode to manufacture a touch screen panel. The touch screen panel may then be attached to the cover substrate 40 via the adhesive layer 94.

The present disclosure also provides a display device including a display panel disposed below the 3D switchable device and outputting an image to the 3D switchable device. The type and structure of the display panel are not limited as long as it can emit 2D polarization and 3D polarization.

### EXAMPLES

### Example 1

First, a first liquid crystal electrode with an average thickness of 1,000 Å made of Al material was formed by metal deposition on a base substrate with an average thickness of a glass material of 0.3 mm, and then, a second liquid crystal alignment layer with an average thickness of 1.5 μm was formed on the first liquid crystal electrode using a photo-alignment method, thereby manufacturing the lower structure.

Then, under a cover substrate with an average thickness of 0.3 mm made of glass, an isotropic planarization layer having a concave portion with a maximum thickness of 20 μm, a minimum thickness of 0 μm, and a curvature radius of 300 μm was formed by UV curing of an isotropic polymer. Next, an anisotropic lens with a maximum thickness of 20 μm, a minimum thickness of 0 μm, and a curvature radius corresponding to the concave portion was formed from RM liquid crystal material in the concave portion of an isotropic planarization layer to manufacture the lenticular lens member. After that, a first liquid crystal alignment layer with a thickness of 1.5 μm was formed under the lenticular lens member using a photo-alignment method, thereby manufacturing the upper structure.

After that, liquid crystal was injected into the area between the lower structure and the upper structure using a vacuum filling method to form a liquid crystal layer with an average thickness of 5 μm, thereby manufacturing the 3D switchable device with the structure shown in FIG. 1.

### Example 2

The same manner as Example 1 were followed, except that before forming the anisotropic lens, a first lens alignment layer with an average thickness of 1.5 μm was formed on the concave portion of the isotropic planarization layer, and after forming the anisotropic lens, a second lens alignment layer with an average thickness of 1.5 μm was formed under the anisotropic lens, resulting in the manufacturing of the 3D switchable device with the structure shown in FIG. 2.

### Example 3

The same manner as Example 1 were followed, except that before forming the first liquid crystal alignment layer under the lenticular lens member, a second liquid crystal electrode with an average thickness of 1,000 Å made of Al was formed under the lenticular lens member, and then the first liquid crystal alignment layer was formed under the second liquid crystal electrode, resulting in the manufacturing of the 3D switchable device with the structure shown in FIG. 3.

### Example 4

The same manner as Example 1 were followed, except that the lenticular lens member was manufactured to include an isotropic polymer layer formed by thermal curing at 200° C., resulting in the manufacturing of the 3D switchable device with the structure shown in FIG. 1.

### Example 5

First, a first liquid crystal electrode with an average thickness of 1,000 Å made of Al material was formed by metal deposition on a base substrate with an average thickness of a glass material of 0.3 mm, and then, a second liquid crystal alignment layer with an average thickness of 1.5 μm was formed on the first liquid crystal electrode using a photo-alignment method.

Then, an intermediate substrate 80 made of a glass material with an average thickness of 0.3 mm having an adhesive layer 81 of an epoxy material with an average thickness of 100 μm was prepared, and then a second liquid crystal electrode made of Al material with an average thickness of 1,000 Å was formed on the back of the intermediate substrate, and after forming a first liquid crystal alignment layer with an average thickness of 1.5 μm material under the second liquid crystal electrode, TN liquid crystal was injected into the region between the second liquid crystal alignment layer and the first liquid crystal alignment layer using a vacuum filling method to form a liquid crystal layer with an average thickness of 5 μm, thereby manufacturing the lower structure.

Subsequently, under a cover substrate with an average thickness of 0.3 mm made of glass, an isotropic planarization layer having a concave portion with a maximum thickness of 20 μm, a minimum thickness of 0 μm, and a curvature radius of 300 μm was formed by UV curing of an isotropic polymer. Next, an anisotropic lens with a maximum thickness of 20 μm, a minimum thickness of 0 μm, and a curvature radius corresponding to the concave portion was formed from RM liquid crystal material in the concave portion of an isotropic planarization layer to manufacture the lenticular lens member and produce the upper structure.

Finally, the upper structure and the lower structure were attached via the adhesive layer of the lower structure to manufacture a 3D switchable device with the structure shown in FIG. 8.

### Experimental Example 1

The following physical properties were evaluated for the 3D switchable devices manufactured according to Examples 1 to 5, and the results are shown in Table 1.

### 1. Thickness Measurement

The total thickness of the 3D switchable devices manufactured according to Examples 1 to 5 was measured using a thickness measuring device (micrometer).

### 2. Evaluation of Optical Properties

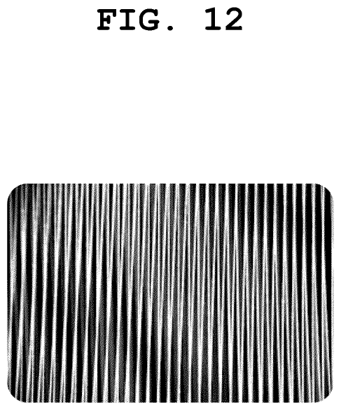

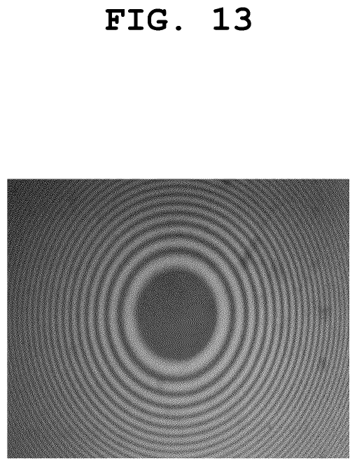

A display panel with an adhesive layer with a thickness of 100 μm on one side was attached to the lower structure of each of the 3D switchable devices manufactured according to Examples 1 to 5, and then optical total power, optical efficiency, and occurrence of optical defects (including Moira patterns (refer to FIG. 12), Newton's rings (refer to FIG. 13), and white spots) were evaluated using an optical measuring device and an external inspection method.

Here, the optical efficiency of Examples 1 to 5 is relatively expressed based on 100 of optical efficiency for Example 13, which will be described later.

In addition, one hundred 3D switchable devices were manufactured according to each of Examples 1 to 5, and the optical defect rate was evaluated by measuring the proportion of optical defects among the hundred devices.

TABLE 1

| Classification | | Example 1 | Example 2 | Example 3 | Example 4 | Example 5 |
|---|---|---|---|---|---|---|
| Thickness (μm) | | 628.1 | 631.1 | 628.2 | 628.1 | 1028.1 |
| Evaluation | optical total | 0.52771 | 0.52763 | 0.52765 | 0.52702 | 0.4963 |
| of optical | power (W/mm²) | | | | | |
| properties | optical | 116% | 116% | 115% | 114% | 106% |
| | efficiency (%) | | | | | |
| | optical defect | 0 | 0 | 0 | 8 | 21 |
| | rate (%) | | | | | |

As shown in Table 1, Examples 1 to 3 had a lower optical defect rate than Example 4, in which the lenticular lens member was manufactured by curing at a high temperature. Compared to Example 5, which included an adhesive layer and an intermediate substrate inside, the thickness of Examples 1 to 3 was significantly thinner, and the optical properties thereof were significantly more superior. Further, the optical defect rate thereof was significantly lower. In Example 4, optical defects occurred due to discoloration caused by high temperature curing and distortion caused by thermal shock.

### Example 6

The same manner as Example 1 were followed, except that before forming the isotropic planarization layer under the cover substrate, a first touch electrode made of ITO material with an average thickness of 1,000 Å was formed under the cover substrate by a metal deposition method, and then the isotropic planarization layer was formed under the first touch electrode, resulting in the manufacturing of the 3D switchable device and a display device with the structure shown in FIG. 4.

### Example 7

The same manner as Example 1 were followed, except that before forming the isotropic planarization layer under the cover substrate, a first touch electrode made of ITO material with an average thickness of 1,000 Å was formed under the cover substrate by a metal deposition method, and the isotropic planarization layer was formed under the formed first touch electrode. Further, before forming the first liquid crystal alignment layer under the lenticular lens member, a second touch electrode made of ITO material with an average thickness of 1,000 Å was formed under the lenticular lens member by a metal deposition method, and then a first liquid crystal alignment layer was formed under the formed second touch electrode, resulting in the manufacturing of the 3D switchable device and a display device with the structure shown in FIG. 5.

### Example 8

The same manner as Example 3 were followed, except that before forming the isotropic planarization layer under the cover substrate, a first touch electrode made of ITO material with an average thickness of 1,000 Å was formed under the cover substrate by a metal deposition method, and then, the isotropic planarization layer was formed under the formed first touch electrode, resulting in the manufacturing of the 3D switchable device and a display device with the structure shown in FIG. 6.

### Example 9

The same manner as Example 7 were followed, except that before forming the first liquid crystal alignment layer under the second touch electrode, an insulating layer 60 material with an average thickness of 1,000 Å was formed under the second touch electrode, and a second liquid crystal electrode made of ITO material with an average thickness of 1,000 Å was formed under the insulating layer, and a first liquid crystal alignment layer was formed under the second liquid crystal electrode, resulting in the manufacturing of the 3D switchable device and a display device with the structure shown in FIG. 7.

### Example 10

The same manner as Example 6 were followed, except that a lenticular lens member was manufactured to include an isotropic polymer layer formed by heat curing of an isotropic polymer at 200° C., resulting in the manufacturing of the 3D switchable device with the structure shown in FIG. 4.

### Example 11

The same manner as Example 1 were followed, except that an upper electrode 91 made of an ITO material with an average thickness of 1,000 Å was formed by a metal deposition method under a touch screen substrate 90 made of a glass material with an average thickness of 0.3 mm, an insulating layer 92 material with an average thickness of 1,000 Å was formed under the upper electrode, and after forming the lower electrode 93 made of ITO material with an average thickness of 1,000 Å under the insulating layer by metal deposition, a touch screen panel was manufactured by forming an adhesive layer 94 made of epoxy material with an average thickness of 100 μm under the lower electrode. Subsequently, the touch screen panel was attached to the cover substrate via the adhesive layer, resulting in the manufacturing of the 3D switchable device with the structure shown in FIG. 9.

### Example 12

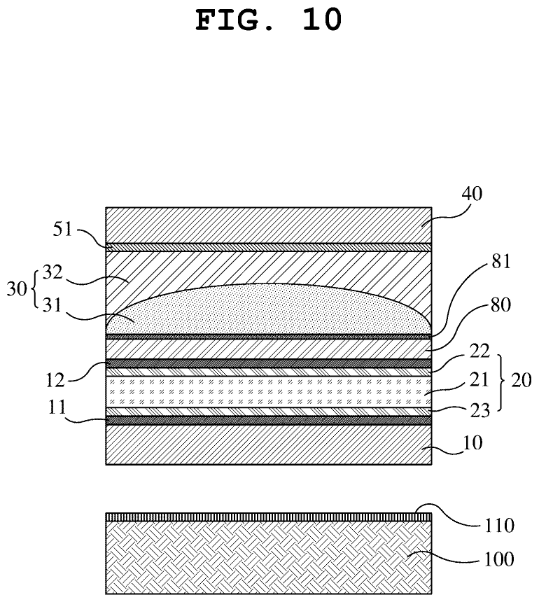

The same manner as Example 5 were followed, except that before forming the isotropic planarization layer under the cover substrate, a first touch electrode 51 made of ITO material with an average thickness of 1,000 Å was formed under the cover substrate by a metal deposition method, and then the isotropic planarization layer was formed under the formed first touch electrode, resulting in the manufacturing of the 3D switchable device with the structure shown in FIG. 10.

### Example 13

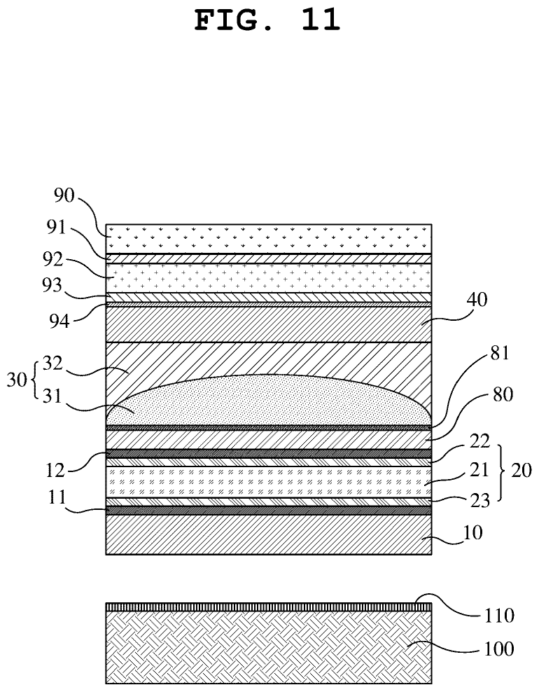

The same manner as Example 5 were followed, except that an upper electrode 91 made of an ITO material with an average thickness of 1,000 Å was formed by a metal deposition method under a touch screen substrate 90 made of a glass material with an average thickness of 0.3 mm, and an insulating layer 92 material with an average thickness of 1,000 Å was formed under the upper electrode. After forming the lower electrode 93 made of ITO material with an average thickness of 1,000 Å under the insulating layer by metal deposition, a touch screen panel was manufactured by forming an adhesive layer 94 made of an epoxy material with an average thickness of 100 μm under the lower electrode, and then the touch screen panel was attached to the cover substrate via the adhesive layer, resulting in the manufacturing of the 3D switchable device with the structure shown in FIG. 11.

### Experimental Example 2

The following physical properties were evaluated for the 3D switchable devices manufactured according to Examples 6 to 13, and the results are shown in Table 2.

### 1. Thickness Measurement

The total thickness of the 3D switchable devices manufactured according to Examples 6 to 13 was measured using a thickness measuring device (micrometer).

### 2. Evaluation of Optical Properties

A display panel with an adhesive layer with a thickness of 100 μm on one side was attached to the lower structure of each of the 3D switchable devices manufactured according to Examples 6 to 13, and then optical total power, optical efficiency, and occurrence of optical defects (including Moira patterns, Newton's rings, and white spots) were evaluated using an optical measuring device and an external inspection method.

Here, the optical efficiency of Examples 6 to 12 is relatively expressed based on 100 of optical efficiency for Example 13.

In addition, one hundred 3D switchable devices were manufactured according to each of Examples 6 to 13, and the optical defect rate was evaluated by measuring the proportion of optical defects among the hundred devices.

TABLE 2

| Classification | | Example 6 | Example 7 | Example 8 | Example 9 | Example 10 | Example 11 | Example 12 | Example 13 |
|---|---|---|---|---|---|---|---|---|---|
| Thickness (μm) | | 628.2 | 628.3 | 628.3 | 628.5 | 628.2 | 1028.4 | 1028.2 | 1430 |
| Evaluation | optical total | 0.52766 | 0.52764 | 0.52762 | 0.52759 | 0.52695 | 0.4692 | 0.5041 | 0.45403 |
| of optical | power (W/mm²) | | | | | | | | |
| properties | optical | 116% | 115% | 115% | 115% | 114% | 102% | 107% | 100% |
| | efficiency (%) | | | | | | | | |
| | optical defect | 0 | 0 | 0 | 0 | 9 | 27 | 22 | 38 |
| | rate (%) | | | | | | | | |

As shown in Table 2, Examples 6 to 9 exhibited a lower optical defect rate than Example 4, in which the lenticular lens member was manufactured by curing at a high temperature, and had a significantly smaller thickness, significantly more superior optical characteristics, and a significantly lower optical defect rate compared to Example 11, which applied the external touch manner. They also had a significantly smaller thickness, significantly more superior optical properties, and a significantly lower optical defect rate compared to Example 12, which included an adhesive layer and an intermediate substrate inside.

Meanwhile, it can be seen that Examples 6 to 9 exhibited no significant difference in thickness and optical characteristics compared to Examples 1 to 3, even though the first and/or second touch electrodes were added thereto.

In Example 10, optical defects occurred due to discoloration caused by high temperature curing and distortion caused by thermal shock.

What is claimed is:

1. A 3D switchable device, comprising:
a base substrate;
a liquid crystal member including a first liquid crystal electrode disposed on the base substrate and a liquid crystal layer disposed on the first liquid crystal electrode, wherein the liquid crystal member selectively blocks or allows 2D polarization and 3D polarization;
a lenticular lens member disposed on the liquid crystal member; and
a cover substrate disposed on the lenticular lens member.

2. The 3D switchable device of claim 1, wherein a separation distance between the liquid crystal member and the lenticular lens member is equal to or less than 350 μm.

3. The 3D switchable device of claim 1, wherein the liquid crystal member and the lenticular lens member are in direct contact with each other.

4. The 3D switchable device of claim 1, wherein the liquid crystal member further includes:
a liquid crystal layer; a first liquid crystal alignment layer disposed adjacent to the base substrate and on a first side of the liquid crystal layer; and
a second liquid crystal alignment layer disposed on a second side of the liquid crystal layer.

5. The 3D switchable device of claim 1, wherein the liquid crystal member is implemented as an In-Plan Switching (IPS) type.

6. The 3D switchable device of claim 1, wherein the lenticular lens member includes:
an anisotropic lens; and
an isotropic planarization layer disposed on the anisotropic lens.

7. The 3D switchable device of claim 6, wherein the lenticular lens member further includes:
a first lens alignment layer disposed on a first side of the anisotropic lens of the lenticular lens member; and
a second lens alignment layer disposed adjacent to the liquid crystal member and on a second side of the anisotropic lens.

8. The 3D switchable device of claim 1, wherein the liquid crystal member further includes a second liquid crystal electrode disposed on the liquid crystal layer facing the first liquid crystal electrode.

9. The 3D switchable device of claim 1, wherein no air layer is formed inside the 3D switchable device.

10. The 3D switchable device of claim 1, wherein no adhesive layer is formed inside the 3D switchable device.

11. A display device, comprising:
the 3D switchable device of claim 1; and
a display panel disposed below the 3D switchable device, wherein the display panel outputs an image to the 3D switchable device.

12. A 3D switchable device, comprising:
a base substrate;
a liquid crystal member including a first liquid crystal electrode disposed on the base substrate and a liquid crystal layer disposed on the first liquid crystal electrode, wherein the liquid crystal member selectively blocks or allows 2D polarization and 3D polarization;
a lenticular lens member disposed on the liquid crystal member;
a cover substrate disposed on the lenticular lens member; and
a first touch electrode for a touch screen interposed between the lenticular lens member and the cover substrate.

13. The 3D switchable device of claim 12, further comprising:
a second touch electrode for the touch screen interposed between the lenticular lens member and the liquid crystal member.

14. The 3D switchable device of claim 13, wherein the liquid crystal member further comprises a second liquid crystal electrode disposed between the liquid crystal layer and the second touch electrode, and
wherein an insulating layer is further included between the second touch electrode and the second liquid crystal electrode.

15. The 3D switchable device of claim 14, wherein the liquid crystal member is implemented as a Twisted Nematic (TN) type or a Vertical Alignment (VN) type.

16. The 3D switchable device of claim 12, wherein no air layer is formed therein.

17. The 3D switchable device of claim 12, wherein no adhesive layer is formed therein.

18. A display device, comprising:
the 3D switchable device of claim 12; and
a display panel disposed below the 3D switchable device, wherein the display panel outputs an image to the 3D switchable device.
